(19) United States
(12) Patent Application Publication
(10) Pub. No.: US 2026/0348729 A1
(43) Pub. Date: Nov. 5, 2026

(54) METHOD AND DEVICE FOR VISUAL INERTIAL FUSION POSITIONING

(71) Applicant: Beijing Zitiao Network Technology Co., Ltd., Beijing (CN)

(72) Inventors: Yunfei FAN, Beijing (CN); Guidong WANG, Beijing (CN); Tao WU, Beijing (CN)

(21) Appl. No.: 19/483,049

(22) PCT Filed: Apr. 23, 2024
(86) PCT No.: PCT/CN2024/089422

§ 371 Date: Nov. 10, 2025

(30) Foreign Application Priority Data
May 9, 2023 (CN) 202310517600.4

(51) Int. Cl. G01C 21/16; G06T 7/73

(52) U.S. Cl. CPC G01C 21/1656; G06T 7/73; G06T 2207/30244

(57) ABSTRACT

Embodiments of the disclosure provide a method and device for visual inertial fusion positioning. The method comprises: obtaining target observation data corresponding to a target state vector; constructing a first residual model according to the target observation data; projecting the residual model according to a first-order partial derivative matrix to obtain a second residual model, the second residual model including a product term of a second-order partial derivative square array and a system state matrix, and a covariance term corresponding to the first observation noise term; and eliminating a three-dimensional coordinate error vector of the second residual model to obtain a target residual model, and performing EKF update to the target state vector according to the target residual model. The embodiment does not involve left zero space calculation and projection as well as QR decomposition and dimension reduction calculation, thus saving calculation amount and improving positioning efficiency.

The present application claims priority to Chinese Patent Application No. 2023105176004, filed on May 9, 2023 and entitled “METHOD AND DEVICE FOR VISUAL INERTIAL FUSION POSITIONING”, which is incorporated herein by reference in its entirety.

### FIELD

Embodiments of the present disclosure relate to a technical field of navigation positioning, and in particular, to a method and device for visual inertial fusion positioning.

### BACKGROUND

Visual Inertial Odometry (VIO) is an algorithm fusing data of a camera and an inertial measurement unit (IMU) to implement simultaneous localization and mapping (SLAM), which may be classified into two major classes based on filtering and optimization. Multi-State Constraint Kalman Filter (MSCKF) is a filtering based VIO algorithm.

However, inventor finds that traditional MSCKF algorithm has at least the following technical problem: calculation amount in a state updating process is large, which affects positioning efficiency.

### SUMMARY

Embodiments of the present disclosure provide a method and device for visual inertial fusion positioning, so as to overcome the problem that calculation amount of an MSCKF algorithm in a state updating process and thus affects the positioning efficiency.

In a first aspect, embodiments of the present disclosure provide a method for visual inertial fusion positioning, including:
obtaining target observation data corresponding to a target state vector, the target observation data including observation data of at least one feature point, and the observation data of each feature point including observation data of the feature point in at least one camera state;
constructing a first residual model according to the target observation data; the first residual model including a product term of a first-order partial derivative matrix and a system state matrix, and a first observation noise term; the first-order partial derivative matrix including a first first-order partial derivative matrix obtained by derivation on the target state vector and a second first-order partial derivative matrix obtained by derivation on a three-dimensional coordinate vector of the at least one feature point; the system state matrix including a target state error vector and a three-dimensional coordinate error vector of the feature point; and the target state vector including an inertial measurement unit IMU state vector and a camera state vector;
projecting the residual model according to the first-order partial derivative matrix to obtain a second residual model; the second residual model including a product term of a second-order partial derivative square array and the system state matrix, and a covariance term corresponding to the first observation noise term; and
eliminating a three-dimensional coordinate error vector of the second residual model to obtain a target residual model, and performing EKF update to the target state vector according to the target residual model.

In a second aspect, embodiments of the present disclosure provide a device for visual inertial fusion positioning, including:
an obtaining module configured to obtain target observation data corresponding to a target state vector; the target observation data includes observation data of at least one feature point; the observation data of each feature point includes observation data of the feature point in at least one camera state; the target state vector includes a plurality of camera states;
a constructing module configured to construct a first residual model according to the target observation data; the first residual model includes a product term of a first-order partial derivative matrix and a system state matrix, and a first observation noise term; the first-order partial derivative matrix includes a first first-order partial derivative matrix obtained by derivation on the target state vector and a second first-order partial derivative matrix obtained by derivation on a three-dimensional coordinate vector of the at least one feature point; the system state matrix includes a target state error vector and a three-dimensional coordinate error vector of the feature point; the target state vector includes an inertial measurement unit IMU state vector and a camera state vector;
a projecting module configured to project the residual model according to the first-order partial derivative matrix to obtain a second residual model; the second residual model includes a product term of a second-order partial derivative square array and the system state matrix, and a covariance term corresponding to the first observation noise term; and
an eliminating module configured to eliminate a three-dimensional coordinate error vector of the second residual model to obtain a target residual model, and perform EKF update to the target state vector according to the target residual model.

In a third aspect, embodiments of the present disclosure provide an electronic device, including a processor and a memory;
the memory stores computer executable instructions;
the processor executes the computer executable instruction stored in the memory, to cause the at least one processor to perform the method for visual inertial fusion positioning of the first aspect and various possible designs of the first aspect.

In a fourth aspect, embodiments of the present disclosure provide a computer-readable storage medium, wherein the computer-readable storage medium stores computer-executable instructions which, when executed by a processor, implement the method for visual inertial fusion positioning of the first aspect and various possible designs of the first aspect.

In a fifth aspect, embodiments of the present disclosure provide a computer program product, including a computer program, wherein the computer program, when executed by a processor, implements the method for visual inertial fusion positioning of the first aspect and various possible designs of the first aspect.

### BRIEF DESCRIPTION OF THE DRAWINGS

In order to more clearly illustrate technical solutions in embodiments of the present disclosure or prior art, drawings used in description of embodiments or prior art are briefly introduced below. It is obvious that the drawings in the following description are some embodiments of the present disclosure, and those of ordinary skill in the art may further derive other drawings from these drawings without the exercise of any inventive effort.

FIG. 1 is a schematic principle diagram of a method for visual inertial fusion positioning provided by embodiments of the present disclosure;

FIG. 2 is a first schematic flowchart of a method for visual inertial fusion positioning provided by embodiments of the present disclosure;

FIG. 3 is a schematic diagram of an observation relationship between a plurality of feature points and a plurality of camera states in a current sliding window corresponding to a target state vector provided by embodiments of the present disclosure;

FIG. 4 is a second schematic flowchart of a visual inertial fusion positioning method provided by embodiments of the present disclosure;

FIG. 5 is a schematic diagram of an observation relationship between a plurality of feature points corresponding to a target state vector and a plurality of camera states in a current sliding window and a plurality of historical camera states in a common window provided by embodiments of the present disclosure;

FIG. 6 is a structural block diagram of a device for visual inertial fusion positioning provided by embodiments of the present disclosure; and

FIG. 7 is a schematic diagram of a hardware structure of a device for visual inertial fusion positioning provided by embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be implemented in various forms, and should not be construed as limited to embodiments set forth herein. On the contrary, these embodiments are provided for a more thorough and complete understanding of the present disclosure. It should be understood that the drawings and embodiments of the present disclosure are for exemplary purposes only and are not intended to limit a scope of the present disclosure.

Embodiments provide a method and device for visual inertial fusion positioning. In the method, first, target observation data corresponding to a target state vector is obtained, the target observation data including observation data of at least one feature point, the observation data of each feature point including observation data of the feature point in at least one camera state, a first residual model is constructed according to the target observation data, the first residual model including a product term of a first-order partial derivative matrix and a system state matrix, and a first observation noise term, the first-order partial derivative matrix including a first first-order partial derivative matrix obtained by derivation on the target state vector and a second first-order partial derivative matrix obtained by derivation on a three-dimensional coordinate vector of the at least one feature point, the system state matrix including a target state error vector and a three-dimensional coordinate error vector of the feature point, and the target state vector including an inertial measurement unit IMU state vector and a camera state vector, a second residual model is obtained by projecting the residual model according to the first-order partial derivative matrix, the second residual model including a product term of a second-order partial derivative square array and the system state matrix, and a covariance term corresponding to the first observation noise term; and a target residual model is obtained by eliminating a three-dimensional coordinate error vector of the second residual model, and the target state vector is updated according to the target residual model. According to the embodiment, the first residual model obtained by fully stacking individual models of a plurality of feature points in a plurality of camera states and by matrix merging is projected to obtain the second residual model including the second-order partial derivative square array, and then the second residual model is subjected to elements elimination to obtain the target residual model to perform state update, the calculation process does not involve left zero space calculation and projection as well as QR decomposition and dimension reduction calculation, thus saving calculation amount and improving positioning efficiency.

In order to make purposes, technical solutions and advantages of embodiments of the present disclosure clearer, the technical solutions in embodiments of the present disclosure will be clearly and completely described below in conjunction with the drawings in embodiments of the present disclosure. Obviously, embodiments to be described are merely part of rather than all of embodiments of the present disclosure. All other embodiments obtained by those skilled in the art based on embodiments of the present disclosure without creative efforts shall fall within the scope of the present disclosure.

Visual Inertial Odometry (VIO) is an algorithm fusing data of a camera and an inertial measurement unit (IMU) to implement simultaneous localization and mapping (SLAM), which may be classified into two major classes based on filtering and optimization. Multi-State Constraint Kalman Filter (MSCKF) is a filtering based VIO algorithm. However, the calculation amount of MSCKF in the state updating process is large, which affects the positioning efficiency. Specifically, the left zero space calculation and the left zero space projection need to be performed on each feature point observation to be state updated, and because number of rows of a matrix in the model obtained after the left zero space projection is far beyond the number of columns, dimension reduction further needs to be performed using the QR decomposition method. This series of complex calculations causes a large amount of overhead in the CPU re-session, which affects calculation efficiency and positioning efficiency.

In order to solve above technical problem, inventor of the present application has found that a first residual model obtained by fully stacking individual models of a plurality of feature points in a plurality of camera states and by matrix merging is projected to obtain a second residual model including a second-order partial derivative square array, and then the second residual model is subjected to elements elimination to obtain a target residual model to perform state update. The calculation process does not involve left zero space calculation and projection as well as QR decomposition and dimension reduction calculation, thus saving the calculation amount and improving the positioning efficiency. Based thereon, an embodiment of the present disclosure provides a method for visual inertial fusion positioning.

Referring to FIG. 1, FIG. 1 is a schematic principle diagram of a method for visual inertial fusion positioning provided by embodiments of the present disclosure. As shown in FIG. 1, a visual inertial fusion system includes a positioning device 101, an IMU 102 and a camera 103. The positioning device 101 uses an Extended Kalman Filter (EKF) framework to predict EKF based on IMU data (IMU readings) sensed by the IMU 102, and updates EKF based on image frames captured by the camera 103, that is, observation data of feature points. Specifically, based on the camera 103 adding camera states (for example, the camera 103 position P and attitude quaternion Q) at different points of time to a state vector, the feature points may be observed by the plurality of cameras 103. Thus, a geometric constraint is formed between the plurality of camera states (Multi-State), and then a residual model may be constructed using the geometric constraint, so as to update EKF. The positioning device 101 may be applied to the fields of robots, drones, augmented reality (AR)/virtual reality (VR) technologies, and the like.

In a specific implementation process, the state vector and the covariance are initialized first, then in the prediction stage, the system basic state and the system covariance are propagated from the image k time point to the image k+1 time point based on each IMU reading, and IMU readings of multiple times are usually processed. In the update stage, the camera 103, after obtaining the image frame at the time point k+1, calculates a current camera state based on the image frame, and adds the current camera state to the state vector to obtain a target state vector, and simultaneously expands the state covariance. A target residual model is constructed based on the observation data corresponding to the target state vector, and EKF is updated based on the target residual model.

Specifically, during constructing a target residual model, target observation data corresponding to a target state vector is obtained, the target observation data including observation data of at least one feature point; the observation data of each feature point including observation data of the feature point in at least one camera state; a first residual model is constructed according to the target observation data; the first residual model including a product term of a first-order partial derivative matrix and a system state matrix, and a first observation noise term; the first-order partial derivative matrix including a first first-order partial derivative matrix obtained by derivation on the target state vector and a second first-order partial derivative matrix obtained by derivation on a three-dimensional coordinate vector of the at least one feature point; the system state matrix including a target state error vector and a three-dimensional coordinate error vector of the feature point; and the target state vector including an inertial measurement unit IMU state vector and a camera state vector; a second residual model is obtained by projecting the residual model according to the first-order partial derivative matrix, the second residual model including a product term of a second-order partial derivative square array and the system state matrix, and a covariance term corresponding to the first observation noise term; a target residual model is obtained by eliminating the three-dimensional coordinate error vector of the second residual model, and an EKF update is performed on the target state vector according to the target residual model.

According to the method for visual inertial fusion positioning provided by embodiments of the present disclosure, a first residual model obtained by fully stacking individual models of a plurality of feature points in a plurality of camera states and by matrix merging is projected to obtain a second residual model including a second-order partial derivative square array, and then the second residual model is subjected to elements elimination to obtain a target residual model to perform state update. The calculation process does not involve left zero space calculation and projection as well as QR decomposition and dimension reduction calculation, thus saving the calculation amount and improving the positioning efficiency.

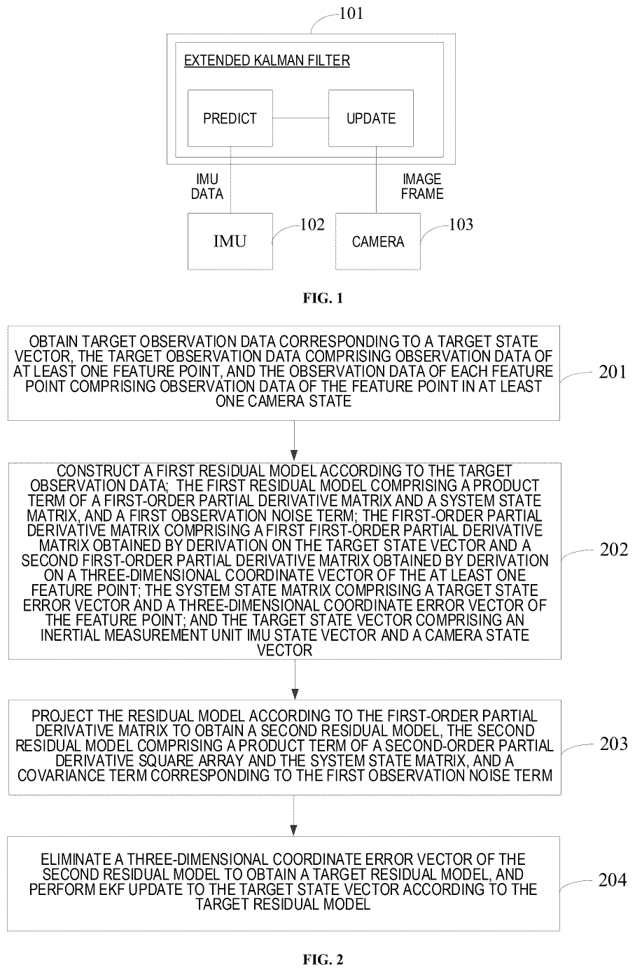

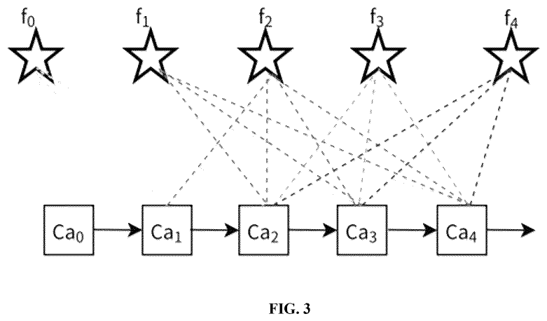

Referring to FIG. 2, FIG. 2 is a first schematic flowchart of a method for visual inertial fusion positioning provided by embodiments of the present disclosure. The method for the embodiment may be applied to the positioning device shown in FIG. 1, and the method for visual inertial fusion positioning includes:
201, obtaining target observation data corresponding to a target state vector, the target observation data including observation data of at least one feature point, and observation data of each feature point including observation data of the feature point in at least one camera state.

In the embodiment of the present disclosure, the target state vector is a system state vector when update timing determined by an update policy is reached. The system state vector XI includes a basic state XA (IMU state) and an extended state XB (camera state), and the basic state XA may include a posture, a displacement, a speed, an accelerometer deviation, and a gyroscope deviation of the IMU, and may further include a camera-to-IMU rotation extrinsic parameter and/or translation extrinsic parameter. The extended state XB may include a rotation, a displacement, and a speed of the camera.

In an embodiment of the present disclosure, to ensure that the system state vector does not increase infinitely and the calculation efficiency is affected, an upper limit value of the extended amount of a sliding window of the system state vector may be set. For example, the upper limit value may be set as n, and then XI=[XA, XB0, XB1, . . . , XBs]. When s=n, to continue extension needs to prune the existing extended state so as to ensure the number of extended states in the sliding window is less than or equal to the upper limit value b. A specific pruning policy (pruning number, pruning position, etc.) may be determined according to actual conditions, which is not limited in embodiments of the present disclosure.

In embodiments of the present disclosure, the observation data of the feature point in the camera state is related data of the image frame including the feature point captured by the camera in the camera state. The content of the target observation data is defined according to the update policy.

For example, in an implementation, all observation data in a sliding window corresponding to feature points that cannot continue to be observed in the current sliding window may be determined as target observation data, and then a residual model is constructed based on the target observation data to perform state update by using an extended Kalman filter (EKF).

In another implementation, the upper limit of the number of extended states in the sliding window may be set to m. When s==m, all the observations of the first 2 or more camera states, or all the observations of the last 2 or more camera states, or all observations of the first and the last or several camera states in a temporal order in the sliding window are extracted as needed, and the extracted observation data is determined as the target observation data, and a residual model is constructed based on the target observation data to perform the state update by using EKF. As to which windows are extracted for state update, a comprehensive decision may be made depending on whether the current system is in motion or whether the motion amount (e.g., the motion distance) reaches a specific limit.

In still another implementation, in order to improve the calculation accuracy, based on any one of the foregoing implementations, in addition to the target observation data separately determined in the foregoing manner, observation data of a historical camera state associated with at least one feature point in the sliding window other than the current sliding window, i.e., earlier than the earliest time in the sliding window, may also be determined as the target observation data. For details, reference may be made to the description of subsequent embodiments, which is not described herein.

Referring to FIG. 3, FIG. 3 is a schematic diagram of an observation relationship between a plurality of feature points and a plurality of camera states in a current sliding window corresponding to a target state vector provided by embodiments of the present disclosure. As shown in FIG. 3, a five-pointed star represents a feature point, a box represents an extended camera state sequence, and a dotted line represents an observation relationship between a feature point and a camera state. The current sliding window corresponding to the target state vector includes feature points f0 to f4, and the camera states include Ca0 to Ca4. Feature point f0 is observed by a camera in five camera states (Ca0 to Ca4), feature point f1 is observed by a camera in three camera states (Ca2 to Ca4), feature point f2 is observed by a camera in four camera states (Ca1 through Ca4), feature point f3 is observed by a camera in three camera states (Ca2 to Ca4), and feature point f4 is observed by a camera in three camera states (Ca2 to Ca4).

In some embodiments, before the constructing a first residual model according to the target observation data, the method may further include: obtaining a plurality of IMU data after a previous time point and before a current time point; obtaining a system state vector to be extended by predicting a system state vector at the previous time point according to the plurality of IMU data; obtaining an image frame at the current time point, calculating a camera state vector corresponding to the image frame according to the image frame, and extending the system state vector to be extended based on the camera state vector to obtain a target state vector.

Specifically, the IMU data between the image k time point and the k+1 time point may be integrated in the prediction stage, and the system basic state and the system covariance are propagated from the image k time point to the image k+1 time point. After obtaining the image frame at the k+1 time point, the camera state calculation and extension are performed to obtain the target state vector.

202, constructing a first residual model according to the target observation data, the first residual model including a product term of a first-order partial derivative matrix and a system state matrix, and a first observation noise term; the first-order partial derivative matrix including a first first-order partial derivative matrix obtained by derivation of the target state vector and a second first-order partial derivative matrix obtained by derivation of a three-dimensional coordinate vector of the at least one feature point; the system state matrix including a target state error vector and a three-dimensional coordinate error vector of a feature point; and the target state vector including an inertial measurement unit IMU state vector and a camera state vector.

Specifically, the feature points may be triangulated based on the camera state in the current sliding window (that is, the three-dimensional coordinates of the feature points are fitted), and then the observation data of the plurality of feature points in the plurality of camera states is determined based on a preset state update policy (which may be described with reference to step 201), so as to construct the first residual model based on the three-dimensional coordinates of the plurality of feature points and the observation data of the corresponding plurality of camera states.

In the triangularization estimation process, the three-dimensional coordinates of the feature points based on the camera state are solved based on a nonlinear optimization algorithm by using a plurality of camera states of different viewing angles (different positions) and observation data of feature points corresponding to the camera state. After the three-dimensional coordinates of the feature points in the camera state are obtained through triangulation estimation, the three-dimensional coordinates: ^{W}P_{f}_{ᵢ} of the feature points in the world coordinate system may be calculated based on the three-dimensional coordinates and the pose relationship of the camera in the world coordinate system, where W represents a world coordinate system, P represents a displacement (position), and i represents an i-th feature point f.

In some disclosed embodiments, the constructing a first residual model according to the target observation data may include: constructing, for each feature point of the at least one feature point and each camera state of at least one camera state corresponding to the feature point, a third residual model according to observation data of the feature point in the target observation data in the camera state; the third residual model including a product term of a first partial derivative matrix and the target state error vector, a product term of a second partial derivative matrix and the three-dimensional coordinate error vector of the feature point, and a second observation noise term; the first partial derivative matrix being a first-order partial derivative of a residual function with respect to the target state vector, and the second partial derivative matrix being a first-order partial derivative of the residual function with respect to a three-dimensional coordinate vector of the feature point; stacking third residual models corresponding to the plurality of feature points to obtain a fourth residual model; and performing matrix merging on a product term in the fourth residual model to obtain a first residual model.

In some disclosed embodiments, the constructing, for each feature point of the at least one feature point and each camera state of the at least one camera state corresponding to the feature point, a third residual model according to the observation data of the feature point in the target observation data in the camera state may include: constructing, for each feature point of the at least one feature point and each camera state of the at least one camera state corresponding to the feature point, the residual function according to the observation data of the feature point in the target observation data in the camera state; the residual function being related to the target state vector and the three-dimensional coordinate vector of the feature point; and performing linearization processing on the residual function to obtain the third residual model.

In some disclosed embodiments, the stacking the third residual models corresponding to the plurality of feature points to obtain the fourth residual model may include: stacking respective third residual models corresponding to the feature points corresponding to the at least one camera state to obtain a fifth residual model; and stacking the respective fourth residual models corresponding to the at least one feature point to obtain the fourth residual model.

In the embodiment of the present disclosure, the first-order partial derivative matrix may be a Jacobian matrix.

Exemplarily, the constraint in vision refers to a reprojection error of the feature point to the camera, that is, an error between the two-dimensional coordinates of the feature points actually observed by the camera and the two-dimensional coordinates projected onto the image by the estimated three-dimensional coordinates of the feature points.

Firstly, a residual function r=f (XI, Pf) is constructed based on the reprojection error, where r is a residual, XI is a target state vector, and Pf is a three-dimensional coordinate of a feature point.

Secondly, a third residual model is constructed based on the observation of the i-th feature point in the j-th camera state:

r_{i,j}=J_{x(i,j)}\acute{X}_{I}+J_{f(i,j)}^{W}\tilde{P}_{f}_{ᵢ}+n_{i,j} (1)

r_{i,j} represents an observation residual of the i-th feature point in the j-th camera state; J_{x(i,j)} (represents a Jacobian matrix determined based on the residual relative to the target state vector, that is, a first partial derivative matrix; \tilde{X}_{I} represents a system state error vector, that is, the target state error vector; J_{f(i,j)} represents a Jacobian matrix determined based on the residual relative to a three-dimensional coordinate corresponding to the i-th feature point, that is, a second partial derivative matrix; ^{W}\tilde{P}_{f}_{ᵢ} represents a three-dimensional coordinate error vector of the i-th feature point in the world coordinate system, that is, a three-dimensional coordinate error vector; and n_{i,j} represents observed noise of the system on the i-th feature point in the j-th camera state, that is, second observation noise.

Again, based on all the observation data in the camera state sequence specified in the sliding window by the i-th feature point, a residual model is constructed, and a fourth residual model in the following matrix mode may be formed by stacking Formula 1:

rᵢ=Jₓ₍ᵢ₎\tilde{X}_{I}+J_{f(i)}^{W}\tilde{P}_{f}_{ᵢ}+nⱼ (2)

rᵢ represents the arrangement or stacking of the observation residuals of the i-th feature point in all specified camera states; Jₓ₍ᵢ₎ represents the arrangement or stacking of the Jacobian matrix determined based on the residual relative to the system state, indicating the system state error vector; \tilde{X}_{I} represents the arrangement or stacking the Jacobian matrix determined based on the residual relative to the three-dimensional coordinate corresponding to the i-th feature point; ^{W}\tilde{P}_{f}_{ᵢ} represents the three-dimensional coordinate error vector of the i-th feature point in the world coordinate system; and nᵢ represents the stacking combination of the observation noises of the system on the i-th feature point in all specified camera states.

Further, the fifth residual model is constructed based on all observations of the feature points that may be used for the state update in the relevant camera states within the sliding window:

r=Jₓ\tilde{X}_{I}+J_{f}\tilde{P}_{f}+n (3)

Jₓ represents a Jacobian matrix determined based on the observation residual in all sliding windows of all the specified feature points relative to the system state variable, J_{f} represents a Jacobian matrix determined based on the observation residual in all sliding windows of all the specified feature points relative to the three-dimensional coordinates of all the feature points used for constructing the residual, and n represents the first observation noise.

Again, matrix merging may be performed on the fifth residual model to obtain the first residual model.

$$r = {\underbrace{[ \begin{matrix}{J}_{x} & {J}_{f}\end{matrix} ]}}_{J} {\underbrace{[ \begin{matrix}{\tilde{X}}_{I} \\ {}^{W} {\tilde{P}}_{f}\end{matrix} ]}}_{\tilde{X}} + n \qquad ( 4 )$$

It may be seen that, in the above Formula (4), the system Jacobian matrix is J=[Jₓ J_{f}], the system state is

$$\tilde{X} = [ \begin{matrix}{\tilde{X}}_{I} \\ {}^{W} {\tilde{P}}_{f}\end{matrix} ] ,$$

\tilde{X}_{I} represents the error amount of the system basic state and the extended state, and ^{W}\tilde{P}_{f} represents the error amount of the three-dimensional coordinates of all the specified feature points. However, the EKF system state variable itself does not contain the three-dimensional coordinates of any feature points, and thus needs to be subjected to elimination subsequently.

For a more vivid understanding of the meaning of Formula (4), it is illustrated below in conjunction with FIG. 3. Assuming that ^{W}\tilde{P}_{f}=[^{W}\tilde{P}_{f0}, ^{W}\tilde{P}_{f1}, . . . , ^{W}\tilde{P}_{fs}], and s=4, the camera pose sequence in the current sliding window may observe the feature points No. 0, 1, 2, 3 and 4. There are 5 extended camera states within the current sliding window, and the observation relationship between the feature point and the camera state is shown in FIG. 3. Formula (4) may thus be expressed in the following form.

The corresponding covariance R is:

203, obtaining a second residual model by projecting the residual model according to the first-order partial derivative matrix, the second residual model including a product term of a second-order partial derivative square matrix and a system state matrix, and a covariance term corresponding to the first observation noise term.

Specifically, to obtain the second-order partial derivative square matrix, a matrix to be projected may be determined based on the dimension of the first-order partial derivative matrix. For example, a transposed matrix of the first-order partial derivative matrix may be determined as the matrix to be projected.

For example, to perform fast elimination, the first residual model shown in Formula (4) may be first projected to [Jₓ J_{f}]^{T} to obtain the following second residual model.

$$[ \begin{matrix}{J}_{x}^{T} \\ {J}_{f}^{T}\end{matrix} ] r = [ \begin{matrix}{J}_{x}^{T} \\ {J}_{f}^{T}\end{matrix} ] [ \begin{matrix}{J}_{x} & {J}_{f} ] [ \begin{matrix}{\tilde{X}}_{I} \\ {}^{W} {\tilde{P}}_{f}\end{matrix} ]\end{matrix} + {n}^{′} , \qquad ( 6 )$$

$$OBSERVATION COVARIANCE {R}^{′} = [ \begin{matrix}{J}_{x}^{T} \\ {J}_{f}^{T}\end{matrix} ] R [ \begin{matrix}{J}_{x} & {J}_{f} ]\end{matrix}$$

204, eliminating a three-dimensional coordinate error vector of the second residual model to obtain a target residual model, and performing EKF update on the target state vector according to the target residual model.

Specifically, after the second residual model including the square matrix is obtained by projecting the first residual model, the three-dimensional coordinate error vector in the system state matrix in the second residual model may be eliminated by using a Gaussian elimination method (specifically, for example, a Schur elimination method).

Exemplarily, in Formula (6), for the vector n, respective members are usually set to the same values, and respective elements of n are denoted as u. Formula (6) may be subjected to the following simplification:

$${\underbrace{[ \begin{matrix}{J}_{x}^{T} r \\ {J}_{f}^{T} r\end{matrix} ]}}_{[ \begin{matrix}{b}_{1} \\ b 2\end{matrix} ]} = {\underbrace{[ \begin{matrix}{J}_{x}^{T} {J}_{z} & {J}_{z}^{T} {J}_{f} \\ {J}_{f}^{T} {J}_{x} & {J}_{f}^{T} {J}_{f}\end{matrix} ]}}_{[ \begin{matrix}{C}_{1} & {C}_{2} \\ {C}_{2}^{T} & {C}_{3}\end{matrix} ]} [ \begin{matrix}{\tilde{X}}_{I} \\ {}^{W} {\tilde{P}}_{f}\end{matrix} ] + {n}^{′} , \qquad ( 7 )$$

$$OBSERVATION COVARIANCE {R}^{′} = {\underbrace{[ \begin{matrix}{J}_{x}^{T} {J}_{z} & {J}_{x}^{T} {J}_{f} \\ {J}_{f}^{T} {J}_{x} & {J}_{f}^{T} {J}_{f}\end{matrix} ] {u}^{2}}}_{[ \begin{matrix}{C}_{1} & {C}_{2} \\ {C}_{2}^{T} & {C}_{3}\end{matrix} ] {u}^{2}}$$

That is:

$$[ \begin{matrix}{b}_{1} \\ b 2\end{matrix} ] = [ \begin{matrix}{C}_{1} & {C}_{2} \\ {C}_{2}^{T} & {C}_{3}\end{matrix} ] [ \begin{matrix}{\tilde{X}}_{I} \\ {}^{W} {\tilde{P}}_{f}\end{matrix} ] + {n}^{′} , \qquad ( 8 )$$

$$OBSERVATION COVARIANCE {R}^{′} = [ \begin{matrix}{C}_{1} & {C}_{2} \\ {C}_{2}^{T} & {C}_{3}\end{matrix} ] {u}^{2}$$

In Formula (8), ^{W}\tilde{P}_{f} is a variable to be eliminated. In order to eliminate ^{W}\tilde{P}_{f}, Formula (8) may be projected to the L space

$$L = [ \begin{matrix}I & - {C}_{2} {C}_{3}^{- 1} \\ 0 & I\end{matrix} ]$$

to obtain the following residual model:

$$L [ \begin{matrix}{b}_{1} \\ b 2\end{matrix} ] = L [ \begin{matrix}{C}_{1} & {C}_{2} \\ {C}_{2}^{T} & {C}_{3}\end{matrix} ] [ \begin{matrix}{\tilde{X}}_{I} \\ {}^{W} {\tilde{P}}_{f}\end{matrix} ] + {n}^{′′} , \qquad ( 9 )$$

$$OBSERVATION COVARIANCE {R}^{′′} = L [ \begin{matrix}{C}_{1} & {C}_{2} \\ {C}_{2}^{T} & {C}_{3}\end{matrix} ] {L}^{T} {u}^{2}$$

After simplification, the following may be obtained:

$$[ \begin{matrix}{b}_{1} - {C}_{2} {C}_{3}^{- 1} {b}_{2} \\ b 2\end{matrix} ] = [ \begin{matrix}{C}_{1} - {C}_{2} {C}_{3}^{- 1} {C}_{2}^{T} & 0 \\ {C}_{2}^{T} & {C}_{3}\end{matrix} ] [ \begin{matrix}{\tilde{X}}_{I} \\ {}^{W} {\tilde{P}}_{f}\end{matrix} ] + {n}^{′′} , \qquad ( 10 )$$

$$OBSERVATION COVARIANCE {R}^{′′} = [ \begin{matrix}( {C}_{1} - {C}_{2} {C}_{3}^{- 1} {C}_{2}^{T} ) {u}^{2} & 0 \\ 0 & {C}_{2} {u}^{2}\end{matrix} ] .$$

Since the EKF system state only contains the camera pose and does not include the three-dimensional coordinates of the feature points, the following may be obtained:

$${\underbrace{[ {b}_{1} - {C}_{2} {C}_{3}^{- 1} {b}_{2} ]}}_{r} = {\underbrace{[ {C}_{1} - {C}_{2} {C}_{3}^{- 1} {C}_{2}^{T} ]}}_{J} {\underbrace{[ {\tilde{X}}_{I} ]}}_{[ \tilde{X} ]} + {n}_{0}^{′′} , \qquad ( 11 )$$

$$OBSERVATION COVARIANCE {R}_{0}^{′′} = [ ( {C}_{1} - {C}_{2} {C}_{3}^{- 1} {C}_{2}^{T} ) {u}^{2} ]$$

It may be learned from Formula (11) that the target residual model after elimination can be sorted into the following standard paradigm.

r=J\tilde{X}+n (12)

Therefore, the EKF update may be performed based on Formula (12) in combination with the following formula.

The gain calculation formula is:

K=PJ^{T}(JPJ^{T}+R)⁻¹ (13)

K represents the Kalman gain, P is the system covariance, and J is the Jacobian matrix.

The state correction amount is calculated as:

ΔX=Kr (14)

The state update formula is:

ΔX=Kr (15)

The covariance update formula is:

P=(I−KJ)P(I−KJ)^{T}+KRK^{T} (16)

In some embodiments of the present disclosure, after the EKF update is completed based on the above formula, the observation data corresponding to the updated feature point will be set, so that the observation data is no longer used for the subsequent EKF update. After setting, an update result, for example, an update result of the target state vector, may be output.

According to the above embodiments of Formulas (1) to (16), the residual model (including the noise model) with the non-existent state variable is projected to the Jacobian transpose space and then projected to a specific space (for example, the space related to the Schur elimination method), to obtain a partial system state that can be mathematically directly eliminated (that is, there is a 0 matrix multiplied by an unnecessary partial system state in the derivation result), so that the projected residual model does not include an unnecessary partial system state. The noise in the residual model is projected to the observation noise model n corresponding to the target state variable by using the Schur elimination matrix, and then the EKF is updated. Therefore, the positioning efficiency is improved on the premise of ensuring the positioning precision.

It may be learned from the above description, a first residual model obtained by full stacking of individual models of a plurality of feature points in a plurality of camera states and by matrix merging is projected to obtain a second residual model including a second-order partial derivative square matrix, and then the second residual model is subjected to elimination to obtain a target residual model for state update. The calculation process does not involve left zero space calculation and projection as well as QR decomposition and dimension reduction calculation, the calculation amount is saved, and the positioning efficiency is improved.

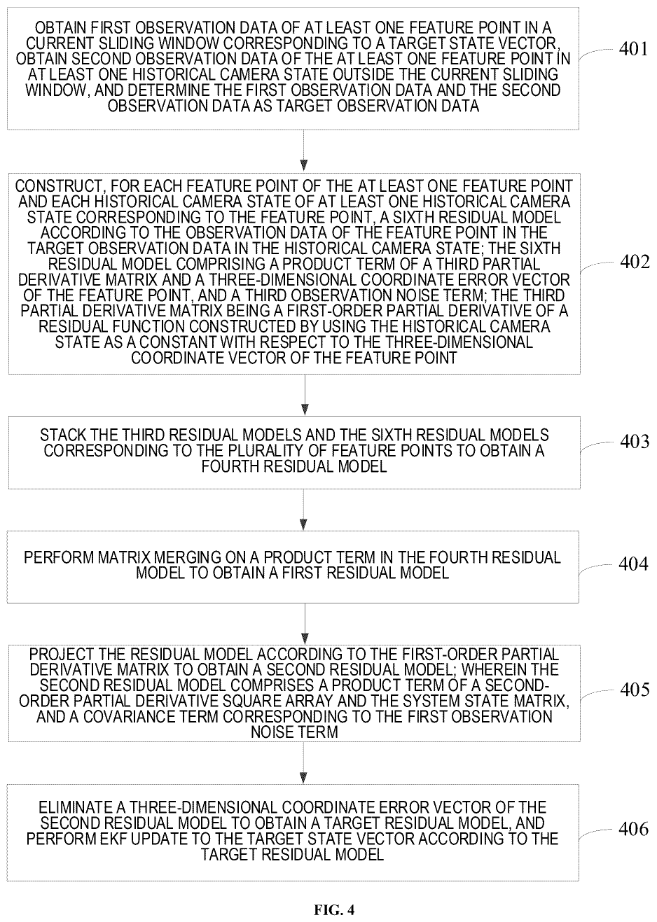

Referring to FIG. 4, FIG. 4 is a second schematic flowchart of a method for visual inertial fusion positioning provided by embodiments of the present disclosure. In order to improve the calculation accuracy, in the embodiment, the application of observation data in a common window is added, and the method for visual inertial fusion positioning includes:

401, obtaining first observation data of at least one feature point in a current sliding window corresponding to a target state vector, and obtaining second observation data of the at least one feature point in at least one historical camera state other than the current sliding window, and determining the first observation data and the second observation data as target observation data.

402, constructing, for each feature point of the at least one feature point and each historical camera state of the at least one historical camera state corresponding to the feature point, a sixth residual model according to the observation data of the feature point in the target observation data in the historical camera state; the sixth residual model including a product term of a third partial derivative matrix and a three-dimensional coordinate error vector of the feature point, and a third observation noise term; the third partial derivative matrix being a first-order partial derivative of a residual function constructed by taking the historical camera state as a constant with respect to a three-dimensional coordinate vector of the feature point.

403, stacking the third residual models and the sixth residual models respectively corresponding to the plurality of feature points to obtain a fourth residual model.

404, performing matrix merging on product items in the fourth residual model to obtain a first residual model.

Specifically, the feature points in the current sliding window might have historical camera states with an observation relationship outside the current sliding window, and if these historical camera states are added to the constraint on the three-dimensional coordinates of the feature points, the data amount of the observation data may be increased, which helps to improve the accuracy of the first-order partial derivation of the three-dimensional coordinates and further improve the accuracy of the residual model and the accuracy of the EKF update.

For example, referring to FIG. 5, FIG. 5 is a schematic diagram of an observation relationship between a plurality of feature points corresponding to a target state vector and a plurality of camera states in a current sliding window and a plurality of historical camera states in a common window provided by embodiments of the present disclosure. As shown in FIG. 5, on the basis of the observation relationship shown in FIG. 3, the observation relationship between the feature point f0 in the common window and the historical camera states Ca-2 to Ca-1 in the common window is increased. The common window refers to a window except the current sliding window, in which there exists a historical camera state having an observation relationship with at least one feature point in the sliding window. Then, the constraint of the feature point f0 and the historical camera states Ca-2 to Ca-1 in the common window may be added to the residual model to obtain the following residual model:

By checking Formula (17) against Formula (5), it may be found that the constraint of the three-dimensional coordinate error vector of the feature point is added based on the observation data of the common window.

According to embodiments of the present disclosure, the residual formed by waypoints which may be observed within the current sliding window and observations of an old window outside the sliding window is added to the current residual construction, the pose (pose and attitude) of the old window is set as a constant, so that the residual thereof forms a constraint on the current EKF solution. Thus, the EKF solution is made more accurate, and the positioning precision becomes higher.

405: projecting the residual model according to the first-order partial derivative matrix to obtain a second residual model, wherein the second residual model includes a product term of a second-order partial derivative square matrix and the system state matrix, and a covariance term corresponding to the first observation noise term;

406, eliminating a three-dimensional coordinate error vector of the second residual model to elimination to obtain a target residual model, and performing EKF update to the target state vector according to the target residual model.

Steps 405 to 406 in the embodiment of the present disclosure are similar to steps 203 to 204 in the foregoing embodiment, and details are not described herein again.

It may be learned from the above description, the observation data of the historical camera state having the observation relationship with the at least one feature point in the current sliding window in the common window, i.e., outside the current sliding window, is added to the construction of the residual model, so that the data amount of the observation data can be increased, which helps to improve the accuracy of the first-order partial derivation of the three-dimensional coordinates and further improve the accuracy of the residual model and the accuracy of the EKF update.

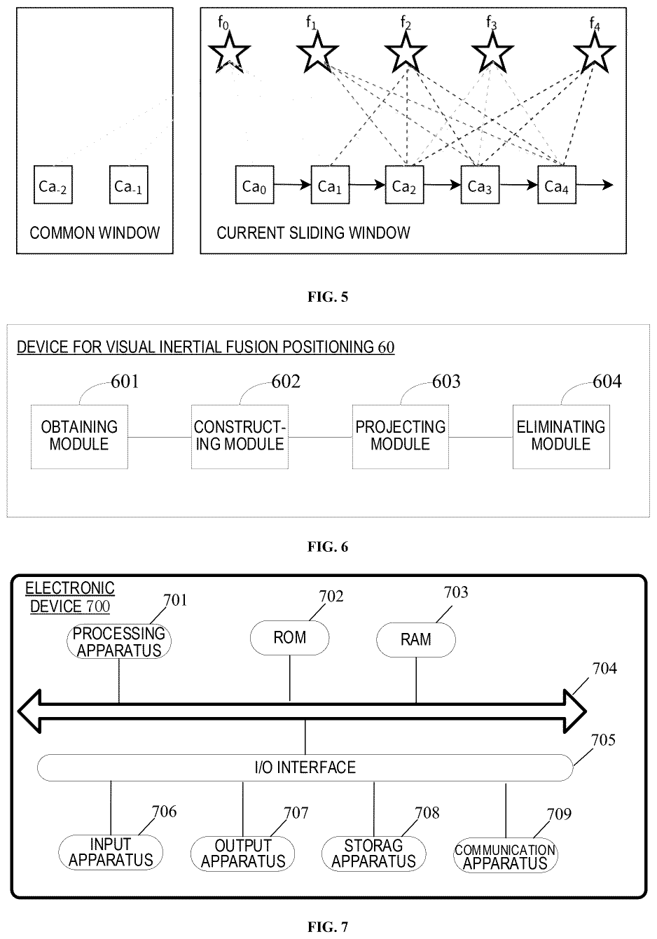

Corresponding to the method for visual inertial fusion positioning in the foregoing embodiment, FIG. 6 is a structural block diagram of a device for visual inertial fusion positioning provided by embodiments of the present disclosure. For ease of illustration, only portions related to the embodiment of the present disclosure is shown. Referring to FIG. 6, the device 60 includes: an obtaining module 601, a constructing module 602, a projection module 603, and an eliminating module 604.

The obtaining module 601 is configured to obtain target observation data corresponding to a target state vector, the target observation data includes observation data of at least one feature point, the observation data of each feature point includes observation data of the feature point in at least one camera state; the target state vector includes a plurality of camera states;

The constructing module 602 is configured to construct a first residual model according to the target observation data, the first residual model includes a product term of a first-order partial derivative matrix and a system state matrix, and a first observation noise term; the first-order partial derivative matrix includes a first first-order partial derivative matrix obtained by derivation on the target state vector and a second first-order partial derivative matrix obtained by derivation on a three-dimensional coordinate vector of the at least one feature point; the system state matrix includes a target state error vector and a three-dimensional coordinate error vector of the feature point; the target state vector includes an inertial measurement unit IMU state vector and a camera state vector;

The projecting module 603 is configured to obtain a second residual model by projecting the residual model according to the first-order partial derivative matrix, the second residual model includes a product term of a second-order partial derivative square array and the system state matrix, and a covariance term corresponding to the first observation noise term;

The eliminating module 604 is configured to obtain a target residual model by eliminating a three-dimensional coordinate error vector of the second residual model, and perform EKF update to the target state vector according to the target residual model.

In an embodiment of the present disclosure, the constructing module 602 is specifically configured to: construct, for each feature point of the at least one feature point and each camera state of at least one camera state corresponding to the feature point, a third residual model according to the observation data of the feature point in the target observation data in the camera state; the third residual model includes a product term of a first partial derivative matrix and the target state error vector, a product term of a second partial derivative matrix and the three-dimensional coordinate error vector of the feature point, and a second observation noise term; the first partial derivative matrix is a first-order partial derivative of a residual function with respect to the target state vector, and the second partial derivative matrix is a first-order partial derivative of the residual function with respect to a three-dimensional coordinate vector of the feature point; stack third residual models respectively corresponding to a plurality of feature points to obtain a fourth residual model; and perform matrix merging on a product term in the fourth residual model to obtain the first residual model.

The constructing module 602 is specifically configured to: construct, for each feature point of the at least one feature point and each camera state of at least one camera state corresponding to the feature point, the residual function according to the observation data of the feature point in the target observation data in the camera state; the residual function is related to the target state vector and the three-dimensional coordinate vector of the feature point; and perform linearization processing on the residual function to obtain the third residual model.

The constructing module 602 is specifically configured to: stack respective third residual models of the feature point corresponding to the at least one camera state to obtain a fifth residual model; and stack fourth residual models respectively corresponding to the at least one feature point to obtain a fourth residual model.

The obtaining module 601 is specifically configured to: obtain first observation data of at least one feature point in a current sliding window corresponding to the target state vector; obtain second observation data of the at least one feature point in at least one historical camera state outside the current sliding window; and determine the first observation data and the second observation data as the target observation data.

The constructing module 602 is further configured to: construct, for each feature point of the at least one feature point and each historical camera state of at least one historical camera state corresponding to the feature point, a sixth residual model according to the observation data of the feature point in the target observation data in the historical camera state; the sixth residual model includes a product term of a third partial derivative matrix and the three-dimensional coordinate error vector of the feature point, and a third observation noise term; the third partial derivative matrix is a first-order partial derivative of a residual function constructed by using the historical camera state as a constant with respect to the three-dimensional coordinate vector of the feature point; and stack the third residual model and a sixth residual model respectively corresponding to the plurality of feature points to obtain a fourth residual model.

The device 60 further includes a prediction and extension module configured to: obtain a plurality of IMU data after a previous time point and before a current time point; obtain a system state vector to be extended by predict a system state vector at the previous time point according to the plurality of IMU data; obtain an image frame at the current time point, calculate a camera state vector corresponding to the image frame according to the image frame, and extend the system state vector to be extended based on the camera state vector to obtain the target state vector.

The eliminating module 604 is specifically configured to: eliminate the three-dimensional coordinate error vector of the second residual model based on a Schur elimination method, to obtain the target residual model.

The device provided in the embodiment may be configured to perform the technical solutions in the foregoing method embodiments, with similar implementation principles and technical effects, and details are not described herein again in the embodiment.

In order to achieve the above embodiments, an embodiment of the present disclosure further provides an electronic device.

Referring to FIG. 7, which is a schematic structural diagram of an electronic device which is applicable to implement embodiments of the present disclosure. The electronic device 700 may be a terminal device or a server. The terminal device may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 7 is merely an example and should not be construed as bringing any restriction on the functionality and usage scope of embodiments of the present disclosure.

As shown in FIG. 7, the electronic device 700 may include a processing apparatus (e.g., a central processor, a graphics processor) 701 which is capable of performing various appropriate actions and processes in accordance with programs stored in a read only memory (ROM) 702 or programs loaded from a storage apparatus 708 to a random access memory (RAM) 703. In the RAM 703, there are also stored various programs and data required by the electronic device 700 when operating. The processing apparatus 701, the ROM 702 and the RAM 703 are connected to one another via a bus 704. An input/output (I/O) interface 705 is also connected to the bus 704.

Usually, the following apparatuses may be connected to the I/O interface 705: an input apparatus 706 including a touch screen, a touch pad, a keyboard, a mouse, a camera, a microphone, an accelerometers, a gyroscope, or the like; an output apparatus 707, such as a liquid-crystal display (LCD), a loudspeaker, a vibrator, or the like; a storage apparatus 708, such as a magnetic tape, a hard disk or the like; and a communication apparatus 709. The communication apparatus 709 allows the electronic device to perform wireless or wired communication with other device so as to exchange data with other device. While FIG. 7 shows the electronic device 700 with various apparatuses, it should be understood that it is not required to implement or have all of the illustrated apparatuses. Alternatively, more or less apparatuses may be implemented or exist.

Specifically, according to embodiments of the present disclosure, the procedures described with reference to the flowchart may be implemented as computer software programs. For example, embodiments of the present disclosure include a computer program product that includes a computer program embodied on a non-transitory computer-readable medium, the computer program including program codes for executing the method shown in the flowchart. In such an embodiment, the computer program may be loaded and installed from a network via the communication apparatus 709, or installed from the storage apparatus 708, or installed from the ROM 702. The computer program, when executed by the processing apparatus 701, performs the above functions defined in the method for embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

The above computer-readable medium may be included in the above-mentioned electronic device; and it may also exist alone without being assembled into the electronic device.

The computer-readable medium carries one or more programs which, when executed by the electronic device, cause the electronic device to perform the method described in the foregoing embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in embodiments of the present disclosure may be implemented as software or hardware. Wherein the name of a unit does not form any limitation to the unit per se. For example, the first obtaining unit may further be described as a “unit for obtaining at least two Internet Protocol addresses.”

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

1. A method for visual inertial fusion positioning, comprising:
obtaining target observation data corresponding to a target state vector, the target observation data comprising observation data of at least one feature point, and the observation data of each feature point comprising observation data of the feature point in at least one camera state;
constructing a first residual model according to the target observation data; the first residual model comprising a product term of a first-order partial derivative matrix and a system state matrix, and a first observation noise term; the first-order partial derivative matrix comprising a first first-order partial derivative matrix obtained by derivation on the target state vector and a second first-order partial derivative matrix obtained by derivation on a three-dimensional coordinate vector of the at least one feature point; the system state matrix comprising a target state error vector and a three-dimensional coordinate error vector of the feature point; and the target state vector comprising an inertial measurement unit IMU state vector and a camera state vector;
projecting the residual model according to the first-order partial derivative matrix to obtain a second residual model, the second residual model comprising a product term of a second-order partial derivative square array and the system state matrix, and a covariance term corresponding to the first observation noise term; and
eliminating a three-dimensional coordinate error vector of the second residual model to obtain a target residual model, and performing EKF update to the target state vector according to the target residual model.

2. The method of claim 1, wherein the constructing a first residual model according to the target observation data comprises:
constructing, for each feature point of the at least one feature point and each camera state of at least one camera state corresponding to the feature point, a third residual model according to the observation data of the feature point in the target observation data in the camera state; the third residual model comprising a product term of a first partial derivative matrix and the target state error vector, a product term of a second partial derivative matrix and the three-dimensional coordinate error vector of the feature point, and a second observation noise term; the first partial derivative matrix being a first-order partial derivative of a residual function with respect to the target state vector, and the second partial derivative matrix being a first-order partial derivative of the residual function with respect to a three-dimensional coordinate vector of the feature point;
stacking third residual models respectively corresponding to a plurality of feature points to obtain a fourth residual model; and
performing matrix merging on a product term in the fourth residual model to obtain the first residual model.

3. The method of claim 2, wherein the constructing, for each feature point of the at least one feature point and each camera state of at least one camera state corresponding to the feature point, a third residual model according to the observation data of the feature point in the target observation data in the camera state comprises:
constructing, for each feature point of the at least one feature point and each camera state of at least one camera state corresponding to the feature point, the residual function according to the observation data of the feature point in the target observation data in the camera state; the residual function being related to the target state vector and the three-dimensional coordinate vector of the feature point; and
performing linearization processing on the residual function to obtain the third residual model.

4. The method of claim 2, wherein the stacking third residual models respectively corresponding to a plurality of feature points to obtain a fourth residual model comprises:
stacking respective third residual models of the feature point corresponding to the at least one camera state to obtain a fifth residual model; and
stacking fourth residual models respectively corresponding to the at least one feature point to obtain a fourth residual model.

5. The method of claim 2, wherein the obtaining target observation data corresponding to a target state vector comprises:
obtaining first observation data of at least one feature point in a current sliding window corresponding to the target state vector;
obtaining second observation data of the at least one feature point in at least one historical camera state outside the current sliding window; and
determining the first observation data and the second observation data as the target observation data.

6. The method of claim 5, wherein the constructing a first residual model according to the target observation data further comprises:
constructing, for each feature point of the at least one feature point and each historical camera state of at least one historical camera state corresponding to the feature point, a sixth residual model according to the observation data of the feature point in the target observation data in the historical camera state; the sixth residual model comprising a product term of a third partial derivative matrix and the three-dimensional coordinate error vector of the feature point, and a third observation noise term; the third partial derivative matrix being a first-order partial derivative of a residual function constructed by using the historical camera state as a constant with respect to the three-dimensional coordinate vector of the feature point; and
wherein the stacking third residual models respectively corresponding to a plurality of feature points to obtain a fourth residual model comprises:
stacking the third residual model and a sixth residual model respectively corresponding to the plurality of feature points to obtain the fourth residual model.

7. The method of claim 1, wherein before the constructing a first residual model according to the target observation data, the method further comprises:
obtaining a plurality of IMU data after a previous time point and before a current time point;
obtaining a system state vector to be extended by predicting a system state vector at the previous time point according to the plurality of IMU data;
obtaining an image frame at the current time point, calculating a camera state vector corresponding to the image frame according to the image frame, and extending the system state vector to be extended based on the camera state vector to obtain the target state vector.

8. The method of claim 1, wherein the eliminating a three-dimensional coordinate error vector of the second residual model to obtain a target residual model comprises:
eliminating the three-dimensional coordinate error vector of the second residual model based on a Schur elimination method to obtain the target residual model.

9. (canceled)

10. An electronic device, comprising: a processor and a memory; wherein
the memory stores computer executable instructions;
the processor executes the computer-executed instructions stored in the memory so as to perform a method for visual inertial fusion positioning, the method comprising:
obtaining target observation data corresponding to a target state vector, the target observation data comprising observation data of at least one feature point, and the observation data of each feature point comprising observation data of the feature point in at least one camera state;
constructing a first residual model according to the target observation data; the first residual model comprising a product term of a first-order partial derivative matrix and a system state matrix, and a first observation noise term; the first-order partial derivative matrix comprising a first first-order partial derivative matrix obtained by derivation on the target state vector and a second first-order partial derivative matrix obtained by derivation on a three-dimensional coordinate vector of the at least one feature point; the system state matrix comprising a target state error vector and a three-dimensional coordinate error vector of the feature point; and the target state vector comprising an inertial measurement unit IMU state vector and a camera state vector;
projecting the residual model according to the first-order partial derivative matrix to obtain a second residual model, the second residual model comprising a product term of a second-order partial derivative square array and the system state matrix, and a covariance term corresponding to the first observation noise term; and
eliminating a three-dimensional coordinate error vector of the second residual model to obtain a target residual model, and performing EKF update to the target state vector according to the target residual model.

11. A non-transitory computer-readable storage medium, wherein the computer-readable storage medium stores computer executable instructions which, when executed by a processor, implement a method for visual inertial fusion positioning, the method comprising:
obtaining target observation data corresponding to a target state vector, the target observation data comprising observation data of at least one feature point, and the observation data of each feature point comprising observation data of the feature point in at least one camera state;
constructing a first residual model according to the target observation data; the first residual model comprising a product term of a first-order partial derivative matrix and a system state matrix, and a first observation noise term; the first-order partial derivative matrix comprising a first first-order partial derivative matrix obtained by derivation on the target state vector and a second first-order partial derivative matrix obtained by derivation on a three-dimensional coordinate vector of the at least one feature point; the system state matrix comprising a target state error vector and a three-dimensional coordinate error vector of the feature point; and the target state vector comprising an inertial measurement unit IMU state vector and a camera state vector;
projecting the residual model according to the first-order partial derivative matrix to obtain a second residual model, the second residual model comprising a product term of a second-order partial derivative square array and the system state matrix, and a covariance term corresponding to the first observation noise term; and
eliminating a three-dimensional coordinate error vector of the second residual model to obtain a target residual model, and performing EKF update to the target state vector according to the target residual model.

12. (canceled)

13. The device of claim 10, wherein the constructing a first residual model according to the target observation data comprises:
constructing, for each feature point of the at least one feature point and each camera state of at least one camera state corresponding to the feature point, a third residual model according to the observation data of the feature point in the target observation data in the camera state; the third residual model comprising a product term of a first partial derivative matrix and the target state error vector, a product term of a second partial derivative matrix and the three-dimensional coordinate error vector of the feature point, and a second observation noise term; the first partial derivative matrix being a first-order partial derivative of a residual function with respect to the target state vector, and the second partial derivative matrix being a first-order partial derivative of the residual function with respect to a three-dimensional coordinate vector of the feature point;
stacking third residual models respectively corresponding to a plurality of feature points to obtain a fourth residual model; and
performing matrix merging on a product term in the fourth residual model to obtain the first residual model.

14. The device of claim 13, wherein the constructing, for each feature point of the at least one feature point and each camera state of at least one camera state corresponding to the feature point, a third residual model according to the observation data of the feature point in the target observation data in the camera state comprises:
constructing, for each feature point of the at least one feature point and each camera state of at least one camera state corresponding to the feature point, the residual function according to the observation data of the feature point in the target observation data in the camera state; the residual function being related to the target state vector and the three-dimensional coordinate vector of the feature point; and
performing linearization processing on the residual function to obtain the third residual model.

15. The device of claim 13, wherein the stacking third residual models respectively corresponding to a plurality of feature points to obtain a fourth residual model comprises:
stacking respective third residual models of the feature point corresponding to the at least one camera state to obtain a fifth residual model; and
stacking fourth residual models respectively corresponding to the at least one feature point to obtain a fourth residual model.

16. The device of claim 13, wherein the obtaining target observation data corresponding to a target state vector comprises:
obtaining first observation data of at least one feature point in a current sliding window corresponding to the target state vector;
obtaining second observation data of the at least one feature point in at least one historical camera state outside the current sliding window; and
determining the first observation data and the second observation data as the target observation data.

17. The device of claim 16, wherein the constructing a first residual model according to the target observation data further comprises:
constructing, for each feature point of the at least one feature point and each historical camera state of at least one historical camera state corresponding to the feature point, a sixth residual model according to the observation data of the feature point in the target observation data in the historical camera state; the sixth residual model comprising a product term of a third partial derivative matrix and the three-dimensional coordinate error vector of the feature point, and a third observation noise term; the third partial derivative matrix being a first-order partial derivative of a residual function constructed by using the historical camera state as a constant with respect to the three-dimensional coordinate vector of the feature point; and
wherein the stacking third residual models respectively corresponding to a plurality of feature points to obtain a fourth residual model comprises:
stacking the third residual model and a sixth residual model respectively corresponding to the plurality of feature points to obtain the fourth residual model.

18. The device of claim 10, wherein before the constructing a first residual model according to the target observation data, the method further comprises:
obtaining a plurality of IMU data after a previous time point and before a current time point;
obtaining a system state vector to be extended by predicting a system state vector at the previous time point according to the plurality of IMU data;
obtaining an image frame at the current time point, calculating a camera state vector corresponding to the image frame according to the image frame, and extending the system state vector to be extended based on the camera state vector to obtain the target state vector.

19. The device of claim 10, wherein the eliminating a three-dimensional coordinate error vector of the second residual model to obtain a target residual model comprises:
eliminating the three-dimensional coordinate error vector of the second residual model based on a Schur elimination method to obtain the target residual model

20. The storage medium of claim 11, wherein the constructing a first residual model according to the target observation data comprises:
constructing, for each feature point of the at least one feature point and each camera state of at least one camera state corresponding to the feature point, a third residual model according to the observation data of the feature point in the target observation data in the camera state; the third residual model comprising a product term of a first partial derivative matrix and the target state error vector, a product term of a second partial derivative matrix and the three-dimensional coordinate error vector of the feature point, and a second observation noise term; the first partial derivative matrix being a first-order partial derivative of a residual function with respect to the target state vector, and the second partial derivative matrix being a first-order partial derivative of the residual function with respect to a three-dimensional coordinate vector of the feature point;
stacking third residual models respectively corresponding to a plurality of feature points to obtain a fourth residual model; and
performing matrix merging on a product term in the fourth residual model to obtain the first residual model.

21. The storage medium of claim 20, wherein the constructing, for each feature point of the at least one feature point and each camera state of at least one camera state corresponding to the feature point, a third residual model according to the observation data of the feature point in the target observation data in the camera state comprises:
constructing, for each feature point of the at least one feature point and each camera state of at least one camera state corresponding to the feature point, the residual function according to the observation data of the feature point in the target observation data in the camera state; the residual function being related to the target state vector and the three-dimensional coordinate vector of the feature point; and
performing linearization processing on the residual function to obtain the third residual model.

22. The storage medium of claim 20, wherein the stacking third residual models respectively corresponding to a plurality of feature points to obtain a fourth residual model comprises:
stacking respective third residual models of the feature point corresponding to the at least one camera state to obtain a fifth residual model; and
stacking fourth residual models respectively corresponding to the at least one feature point to obtain a fourth residual model.
